(19) United States
(12) Patent Application Publication
(10) Pub. No.: US 2004/0051948 A1
(43) Pub. Date: Mar. 18, 2004

(54) Systems, methods, and apparatus for patterned sheeting

(76) Inventor: David Reed, Sebastopol, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/659,799

(22) Filed: Sep. 10, 2003

Related U.S. Application Data
(60) Provisional application No. 60/410,206, filed on Sep. 11, 2002.

(51) Int. Cl. G02B 5/122; B29C 47/32; B29D 11/00

(52) U.S. Cl. 359/529; 425/382.3; 425/363; 264/1.6; 264/1.9

(57) ABSTRACT

A patterned roller including one or more patterned rings forming an overall cylindrical pattern. The patterned roller may also include one or more spacer rings to form grooves or channels into a surface. The patterned roller may be included in a roller stack as part of a manufacturing system for patterned film. The patterned roller can include a pattern to form full corner cubes of many different sizes and/or geometries in a continuous manner across the width and along the length of a reflective sheet without seams. Methods of manufacture include rolling the cylindrical pattern of the patterned roller into a surface of an extruded sheet. Articles are manufactured utilizing the methods of manufacture including license plates, shoes, highway signs, articles of clothing, pavement markers, automobile reflectors, and bicycle reflectors.

### CROSS-REFERENCE TO RELATED APPLICATIONS

This United States (US) non-provisional patent application filed by David Reed claims the benefit of U.S. provisional patent application Serial No. 60/410,206, filed by David Reed on Sep. 11, 2002.

### FIELD OF THE INVENTION

The invention relates generally to the field of patterned sheeting. Particularly, the invention relates to reflective and retro-reflective sheeting.

### BRIEF DESCRIPTION OF THE DRAWINGS

FIG. 1 is a perspective view of a film squeezed between an embodiment of a patterned roller and another roller.

FIG. 2 is an exploded view of a patterned ring or shim and a pair of spacer rings or shims from the patterned roller of FIG. 1.

FIG. 3 is a magnified view of a portion of FIG. 2.

FIG. 4A is a perspective view of another embodiment of a patterned roller which is partially assembled together.

FIG. 4B is a perspective view of the patterned roller of FIG. 4A with all patterned rings or shims and/or spacer rings or shims assembled together.

FIG. 4C is a magnified view of a portion of the patterned roller of FIG. 4A.

FIG. 5 is a perspective view of a patterned ring or shim of the patterned roller of FIG. 4A.

FIG. 6 is a magnified view of a portion of the patterned roller of FIG. 4A.

FIG. 7 is a magnified view of a portion of FIG. 6.

FIGS. 8A-8B are views of a portion of a reflective film having full corner cubes to reflect incident light.

FIGS. 9A-9B are exploded side views of other layers and their orientation prior to lamination together with the reflective film.

FIG. 10 is a schematic diagram of an exemplary manufacturing system with a roller stack including the patterned roller.

FIG. 11 is a front view of a patterned roller assembly including the patterned roller.

FIG. 12 is a perspective view of an exemplary roll of reflective film.

FIGS. 13A-13G illustrate applications of reflective film.

Like reference numbers and designations in the drawings indicate like elements providing similar functionality.

### DETAILED DESCRIPTION OF THE INVENTION

In the following detailed description of the invention, numerous specific details are set forth in order to provide a thorough understanding of the invention. However, it is to be understood that the invention may be practiced without these specific details. In other instances well known methods, procedures, elements, components, and equipment have not been described in detail so as not to unnecessarily obscure aspects of the invention.

Reflectors may use an array of ball or spherical lenses formed out of an optical material to reflect radiation. In other cases, a reflector may use an array of half corner cubes formed out of an optical material to reflect radiation. In some cases, half corner cubes may be combined with ball or spherical lenses to reflect radiation. In other instances, a reflector may use an array of full corner cubes formed out of an optical material to reflect radiation.

The present invention includes methods and apparatus for manufacturing reflective sheeting or film that may be used as a reflector or an element of a reflector. The reflective sheeting or film may have a surface of optical material formed with a microstructured array of half corner cubes or full corner cubes in order to reflect the radiation. In one embodiment, the reflective sheeting or film of the present invention may be formed in an extrusion process using a patterned roller.

Half corner cubes have two boundary surfaces where the incident radiation is reflected twice in order to redirect back toward the incident light source. Full corner cubes use three boundary surfaces where the incident radiation is reflected thrice in order to redirect back toward the incident light source. Full corner cubes typically provide larger range of angles over which incident light may be received and redirected back towards the light source. Provided that the losses are low in the optical material, full corner cubes tend to be more reflectively efficient that half corner cubes. However, full corner cubes are more difficult to manufacture. Typically, reflective film is formed out of a thin film that is embossed with a half corner cube pattern that naturally reflects incident light at a pre-determined angle.

Typical methods of manufacturing an array of half corner cubes into a reflective sheeting or film are by molding, machine cutting, and stamping processes.

The molding process typically requires a mold which is fixed for a given pattern. A molten plastic or other similar optical material in liquid form is poured over and into the mold. The optical material requires a curing time in the mold in order to take a shape which has reflective properties. The curing time can be significant. Additionally, a mold does not lend itself to form full corner cubes in the optical material.

The machine cutting process typically requires a machine tool to individually scribe a pattern into a plastic or other optical material. Individually scribing a pattern is very time consuming and is not a cost effective method of manufacturing a continuous sheet of reflective material.

A stamping process typically requires a rectangular stamp which has a fixed pattern. A soft semi-solid or semi-liquid optical material, such as plastic, is stamped by the stamp into a shape which has reflective properties. Stamping a finite area with a rectangular stamp is also slow and less cost effective.

These typical processes oftentimes introduce seams in between reflective patterns in the reflective sheeting or film in order to provide an adequate size. The seams break up the reflective pattern and are non-reflective thereby reducing the reflectivity or intensity efficiency.

Each of these typical processes may form unbroken half corner cube patterns over a limited area—for example, no larger than nine inches by nine inches unbroken pattern (i.e. a “nine inch pattern block”) with thirty-six nine inch pattern blocks within a forty-eight inch by forty-eight inch sheet. In some cases, the nine inch pattern block may limit the application to this size or otherwise require meticulous splicing to create larger patterns.

The present invention can provide a microstructured film on a continuous roll, without seams, to provide customers with a seamless reflective film of nearly any length. By eliminating the seams in the manufacture of reflective sheeting, reflectivity efficiency can be increased and costs can be reduced by the increased density of the reflective pattern.

To provide continuous roll of a reflective film, a microstructured cylindrical die with the optical pattern cut into its surface is provided. The microstructured cylindrical die is referred to herein as a patterned roller. This microstructured cylindrical die presses its pattern into the plastic film, continuously imprinting the pattern into a warm optical material such as a warm plastic. In typical processes, it is difficult to cut a half or a full corner cube pattern into a cylindrical die.

The patterned roller provides the tooling for a manufacturing process that allows for continuous manufacture of a microstructured reflective film, with either and/or both half corner cubes and full corner cubes. Accurate corner cube grooves can be formed on a three dimensional surface. Rather than a solid cylinder or roller, the patterned roller forms a cylindrical pattern out of multiple pieces or subpatterns. The patterned roller uses one or more narrow annular rings or shims packed tightly together to form an overall cylindrical pattern. Each ring or shim is individually cut to make up a portion of the pattern. In one embodiment, the rings are less than one millimeter wide. By using various numbers of rings or shims placed tightly side by side, a cylinder of varying widths with a desired pattern can be formed.

The patterned roller can provide large, unbroken reflective surfaces with full corner cubes. That is, a surface of the reflective film or sheeting can be formed into a wide and infinitely long unbroken reflective surface. By using one or more rings or shims to form the overall cylindrical pattern of the patterned roller, adjustment of the angles of the surfaces of the full corner cubes may be made, including having different angles on each ring. Full corner cubes may be provided by alternating the alignment of subpattern across rings, from ring to ring. As a result, a number of reflective angles and reflective effects may be made into a surface of an optical material to provide the reflective or retro-reflective of incident light or radiation. The cube angles (i.e., wider or narrower) and the depth (i.e., shallower or deeper) of the cube can be readily adjusted varying their orthogonality by changing the rings or shims of the overall cylindrical pattern to change the reflective characteristics of a reflective film and an end product. Larger, deeper cubes can be formed into a surface without sacrificing the reflective quality. The patterned roller is adaptable in that different reflective sheeting or film can be manufactured using different configurations of the same tool. The overall cylindrical pattern need only be modified by changing the configuration of rings or shims over the cylindrical pattern. Over a single patterned roller, there can be many sizes and kinds of corner cubes coincidentally co-existing over the extent of the cylindrical face of the roller to form the overall cylindrical pattern.

The patterned roller includes a base cylinder, serving as a holder for the rings or shims. The base cylinder contains one or more guides lengthwise, that serve to align the rings properly and help hold them securely coupled together. The outside diameter and shape of the base cylinder is similar to the inside diameter and shape of the rings, to retain the positions of the rings/shims and avoid shifting of the pattern.

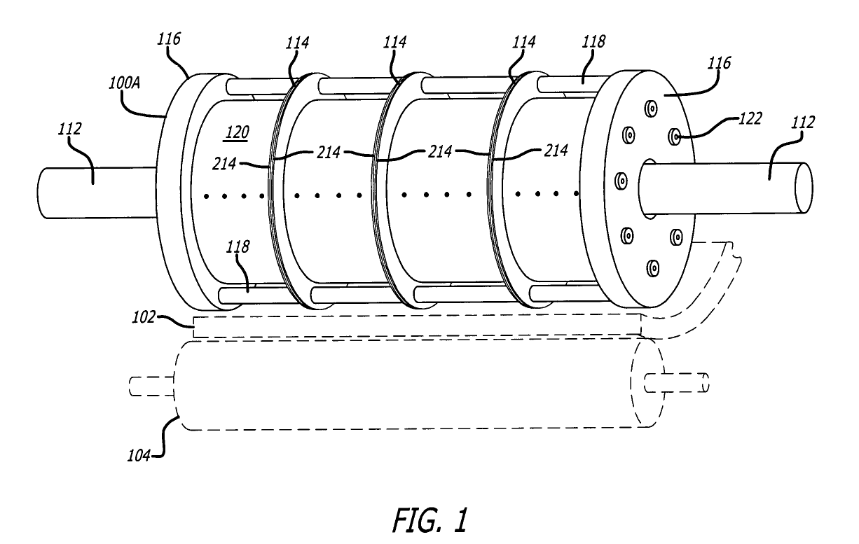

Referring now to FIG. 1, a first embodiment of a patterned roller 100A is illustrated. The patterned roller 100A may also be referred to as a patterned drum or a patterned revolving cylinder. The patterned roller 100A includes a cylindrical pattern. In the preferred embodiment, the cylindrical pattern is used to form microstructures in a surface of a material layer.

An optical film or layer may be sandwiched between the patterned roller 100A and another roller 104. In the preferred embodiment, the pattern of the patterned roller 100A is formed into a surface of the optical film or layer to generate a continuous pattern of a patterned or reflective film, layer of sheet 102.

In one embodiment, the optical film or layer is a plastic material heated into a soft state between a liquid and a solid so that the cylindrical pattern of the patterned roller 100A is imprinted into a surface of the optical film. In another embodiment, the pattern of the patterned roller 100A is sufficiently sharp to cut into a surface of the optical film in its solid state.

As illustrated in FIG. 1, the patterned roller 100A may include one or more rotatable axles, shafts, or journals 112, one or more N patterned shims/rings 114, M spacer shims/rings (not illustrated in FIG. 1), a pair of end flanges 116, a pair of rods 118, a center cylindrical sleeve 120, and one or more fasteners 122 at each end flange 116. The center cylindrical sleeve 120 may also be referred to as a cylindrical core 120. The respective number N and M of the one or more patterned rings and spacer shims/rings depends upon the desired cylindrical pattern of the patterned roller and the optical film. In one embodiment, M=N+1. In another embodiment, M=0 and no spacer shim/ring is used. The patterned shims/rings 114 have a width which is a function of the desired pattern. The spacer shims/rings may not have a pattern cut or formed into them but may be sized appropriately to form a straight line, groove or an indentation pattern in the surface of the film. The spacer shims/rings may be considered to have an edge pattern that forms the straight line, the groove or the indentation pattern in a surface.

The patterned roller 100A rotates about the one or more axles 112 as one or more material layers of film are pushed and/or pulled through between the patterned roller and the roller 104 to form the reflective film 102. The cylindrical pattern of the one or more of the N patterned shims and the M spacer shims is formed into a surface of the reflective film 102 as the patterned roller rolls over it. The pattern formed in the surface of the film can be considered a continuous pattern. The one or more of the N patterned shims 114 are located around the center cylindrical sleeve 120. The pair of rods 118 retain the one or more of the N patterned shims 114 as well as the M spacer shims (not illustrated), if any, in a fixed position on the patterned roller 100A. The end flanges 116 sandwich the one or more of the N patterned shims 114; the M spacer shims, if any; one or more rods 118; and the center cylindrical sleeve 120 between them. The fasteners 122, at each of the end flanges 116, squeeze the end flanges 116 together and hold the other elements sandwiched between them together as a unit. In one embodiment, the fasteners 122 are each a nut and bolt combination.

The N patterned shims and the M spacer shims, if any, slidingly couple to one or more rods 118. The one or more rods 118 are located around the patterned roller parallel to the axle 112. The one or more rods 118 may be located on opposite sides of the patterned roller 100A as illustrated or spaced apart at angles from each other around the patterned roller 100A. FIG. 1 illustrates a pair of rods 118 located on opposite sides and spaced equally by one hundred eighty degrees from each other. However, there may be one, two, three, four or more rods 118 located around the patterned roller 100A to retain the shims.

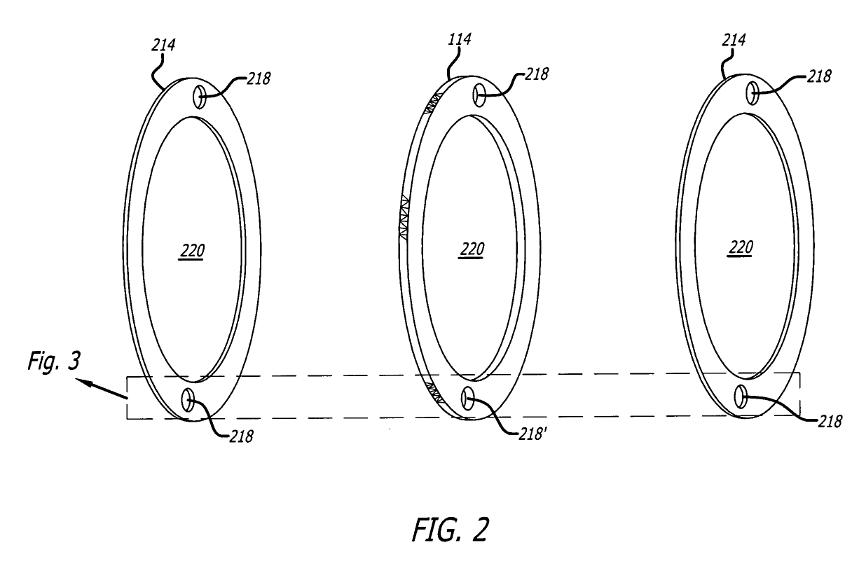

Referring now to FIG. 2, an exploded view of the patterned shim 114 and a pair of spacer shims 214 is illustrated. When assembled on the patterned roller 100A, the patterned shim 114 may be sandwiched by the pair of spacer shims/rings 214. Each of the spacer shims 214 include one or more alignment holes 218 to slide over the one or more rods 118. Similarly, each of the patterned shims 114 includes one or more alignment holes 218′ to slide over the one or more rods 118. Additionally, each spacer shim 214 and patterned shim 114 include a center opening 220 to slide over the center cylindrical sleeve 120.

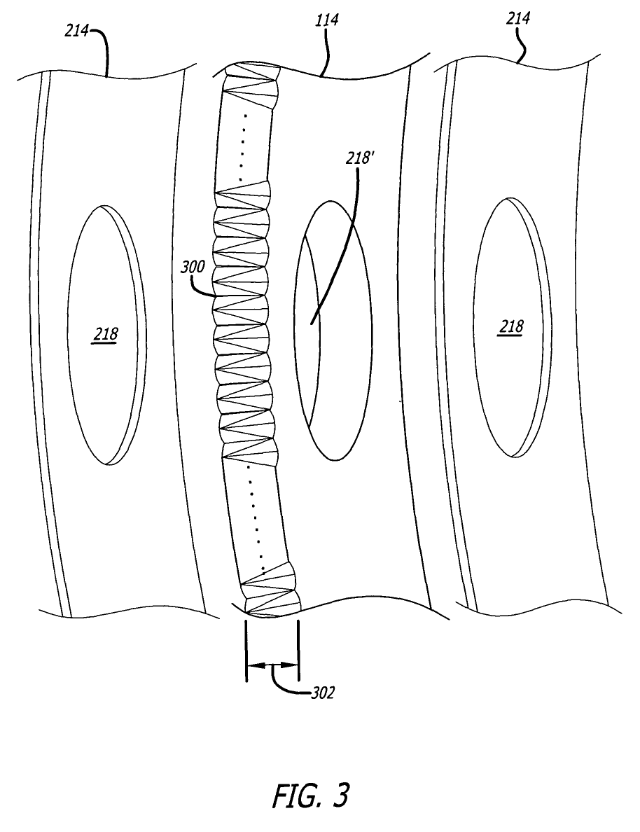

Referring now to FIG. 3, a magnified view of a portion of FIG. 2 is illustrated. Each of the one or more patterned shims 114 includes a subpattern 300 around its outer edge. In the case of one patterned shim 114, the subpattern 300 of the one patterned shim 114 may be the overall pattern if no spacer shim 214 is used to form part of the overall pattern. Each of the subpatterns 300 of each patterned shim 114 may be similar or unique in order to complete the overall cylindrical pattern of the patterned roller which is rolled into the surface of the reflective film 102. The subpattern 300 may alternate between odd and even patterned shims 114. The subpattern 300 of each patterned shim 114 may be the same but the subpattern may be slightly offset from one patterned shim 114 to the next patterned shim on the patterned roller 100. The overall cylindrical pattern of the patterned roller 100 may be readily changed by replacing the patterned shims 114 and any spacer shims with a different configuration of patterned shims and spacer shims.

Each of the patterned shims includes a thickness 302 which may vary depending on the subpattern selected for a given patterned shim. In comparison, the thickness of the spacer shims 214 is substantially small. For example, in one embodiment the thickness of the spacer shims is twenty five percent of the thickness of the patterned shims. However, the spacer shims 214 do form their own subpattern within the overall pattern. In one case, the spacer shims 214 may form a groove or a line in a surface of the film. While the thickness of the spacer shims 214 are illustrated as being substantially small or nil in FIG. 3, they may be provided with a more substantial thickness to further define a subpattern within the over all pattern.

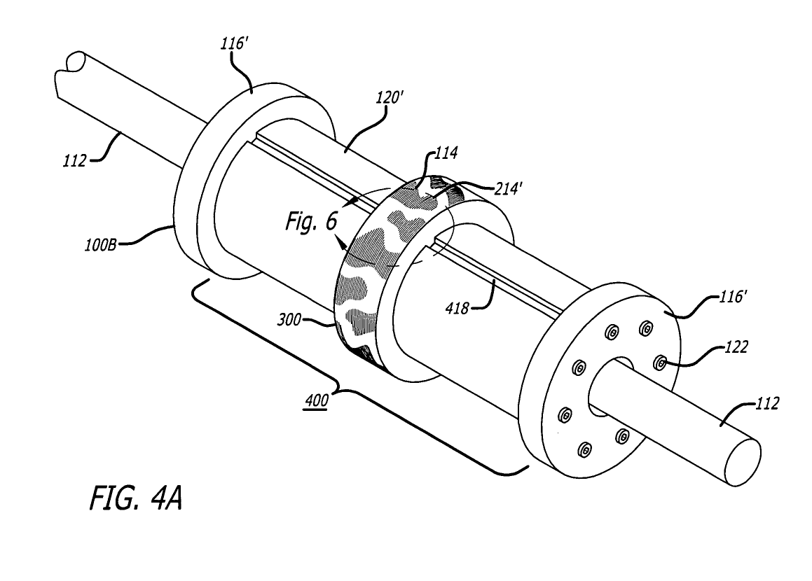

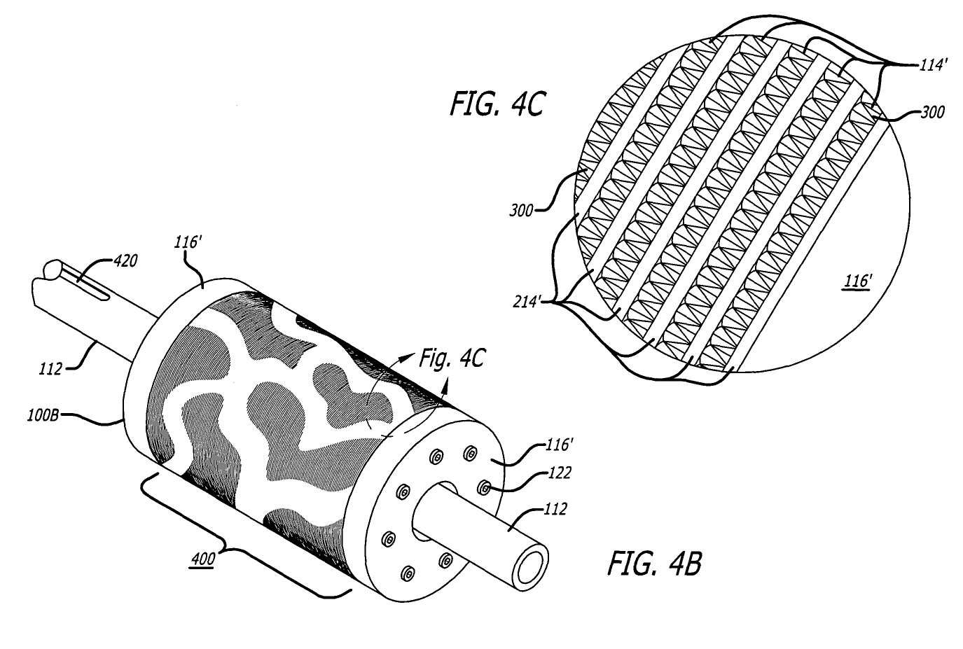

Referring now to FIG. 4A, a second embodiment of a patterned roller 100B is illustrated. The patterned roller 100B may also be referred to as a patterned drum or a patterned revolving cylinder. The patterned roller 100B includes a number of elements of the patterned roller 100A. The patterned roller 100B includes a cylindrical pattern. In the preferred embodiment, the cylindrical pattern is to form microstructures in a surface of a material layer. However, the patterned shims and the spacer shims are retained differently in each of the respective patterned rollers.

Patterned roller 100B includes one or two shafts, journals or axles 112, one or more of the N patterned shims 114′, M spacer shims 214′, a pair of end flanges 116′, a center cylindrical sleeve 120′, and one or more fasteners 122. The center cylindrical sleeve 120′ may also be referred to as a cylindrical core 120′. In the embodiment of the patterned roller 100B, the center cylindrical sleeve 120′ includes a guide slot 418. The guide slot 418 engages with a guide tab in each patterned shim 114′ and each spacer shim 214′ to retain the angular orientation of each around the center cylindrical sleeve 120′. The end flanges 116′ differ slightly from the end flanges 116 of FIG. 1 because the guide slot 418 may be used without the one or more rods 118.

Referring now to FIG. 4B, all of the patterned shims 114′ and/or spacer shims 214′ are assembled together on the patterned roller 100B to form a cylindrical pattern 400. Due to the micromachined surfaces in the one or more patterned shims 214′, details of the cylindrical pattern 400 are not illustrated in FIG. 4B and it may appear to be all black.

Referring now to FIG. 4C, a magnified view of a portion of the patterned roller 100B is illustrated. The cylindrical pattern 400 may include one or more of the patterned shims 114′ and zero or more of the spacer shims 214′ between the pair of end flanges 116′. The spacer shims 214′ may be located on either side of a patterned shim 114′. Alternatively, patterned shims 114′ may be adjacent each other in some cylindrical pattern 400. One or more patterned shims 114′ may be located on either side of a spacer shim 214′. Alternatively, spacer shims 214′ may be adjacent each other in another cylindrical pattern 400.

The subpattern 300 may be formed in each patterned shim 114′ around the outside circumference or outer edge of each shim. The subpattern 300 may repeat around the outside circumference of the patterned shim. Alternatively, the subpattern 300 may be unique along any arc or the entire circumference of a given patterned shim 114′.

The subpattern 300 may be unique to each shim 114 within the overall cylindrical pattern 400. That is, no two patterned shims 114′ may be alike. Alternatively, a set of patterned shims 114 may each be unique within the set, with the set of patterned shims 114 being repeated across the overall cylindrical pattern 400. In yet another embodiment, each pattern shim 114′ may have the same identical subpattern 300 to form some overall cylindrical pattern 400. In this manner, the cylindrical pattern 400 is easily adaptable to form a pattern in a surface of a material.

Referring back to FIG. 4B, a drive groove 420 formed into an the one or more axles 112 is illustrated. The drive groove 420 is parallel with and near an end of the one or more axles 112. On one axle of one or more axles 112 or one side of an axle 112, the drive groove 420 may be provided to couple to the axle to a drive gear or motor to rotate the patterned roller 100B. In one embodiment, a key (not shown) may be positioned into the drive groove 420 to couple to a keyway of a gear or other drive coupler. In another embodiment, the gear or other drive coupler may have a tab that slides into the drive groove 420. In another embodiment, the drive groove 420 may be configured as a drive key extending outward from the cylindrical surface of the axle.

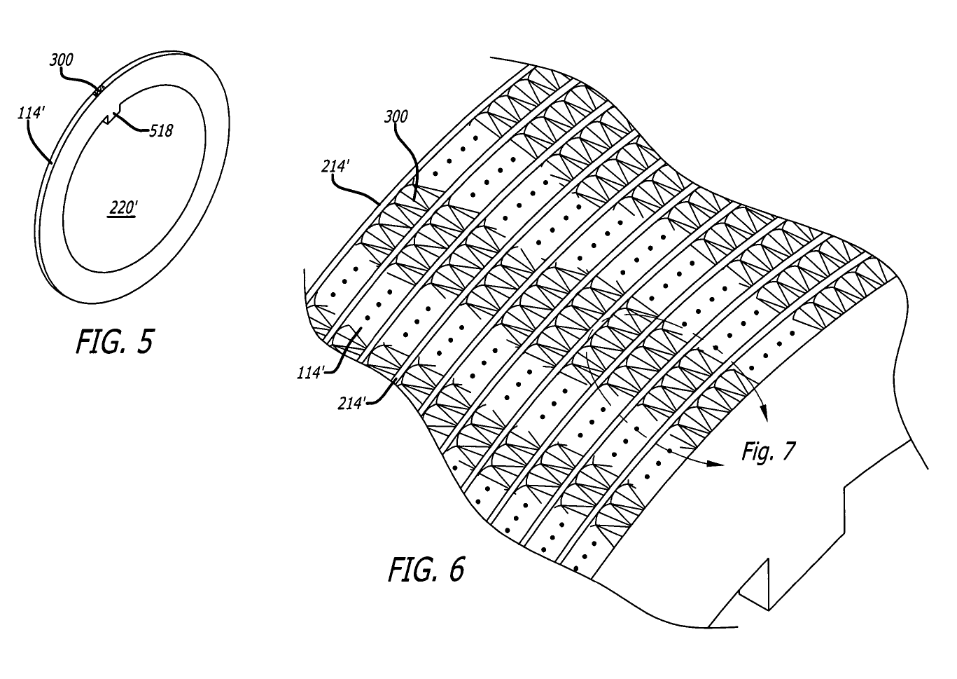

Referring now to FIG. 5, a perspective view of the patterned shim 114′ is illustrated. The patterned shim 114′ illustrated in FIG. 5 is exemplary of the N patterned shims 114′ of the patterned roller 100B. The patterned shim 114′ includes the center opening 220′, the guide tab 518, and the subpattern 300. The guide tab 518 is located on the inside edge of the patterned shim 114′ in the center opening 220′. The center opening 220′ allows the patterned shim 114′ to slide over outside surface of the center cylindrical sleeve 120′. The guide tab 518 of the patterned shim 114′ slides within the guide slot 418 as the center opening 220′ slides over the outside surface of the cylindrical sleeve 120′.

The patterned shims 114 and 114′ as well as the spacer shims 214 and 214′ are generally ring shaped or annular. The patterned shims 114 and 114′ as well as the spacer shims 214 and 214′ may also be considered to be generally shaped as a hollow cylinder with a finite thickness and height. The outer edge of each of the patterned shims varies around its outer edge or circumference due to the subpattern 300. The spacer shims may be constant or vary around its outer edge or circumference. The inner edge or surface of the patterned shims and spacer shims is shaped to match the shape of the center cylindrical sleeve 120. In one embodiment, the center cylindrical sleeve 120 is a circular cylinder such that the inner edge or surface of each of the spacer shims and patterned shims are generally a circular cylindrical shape as well. In other embodiments, the inner edge may be a square, a rectangular, a hexagon or another cylindrical shape to match the shape of the center cylindrical sleeve.

The spacer shims 214 and the patterned shims 114′ assemble onto the center cylindrical sleeve 120′ with the guide tabs 518 of each being aligned with the guide slot 418.

Referring now to FIG. 6, a magnified view of another portion of the rings/shims of the patterned roller 100B is illustrated. As previously discussed, the patterned shim 114′ may be sandwiched by a pair of spacer shims 214′. The subpattern 300 of each patterned shim 114′ is repeated around the outside circumference or outer edge thereof.

Referring now to FIG. 7, a magnified view of a portion of the shims/rings of FIG. 6 is illustrated. The subpattern 300 continues around the outer edge or circumference of the patterned rings 114′. The subpattern 300 may form corner-cubes within an area of the reflective film 102. The space shims or rings 214′ may form a groove, slot, or line within the reflective film 102 separating columns of corner-cubes formed by the subpattern 300 of each patterned shim/ring 114′.

The subpattern 300 may be machined into the patterned rings 114 or 114′ using a precision cutting tool. Alternatively, the patterned rings 114 or 114′ may be molded or cast to include the subpattern 300 along the outer edge. A unique subpattern may be formed into each patterned ring. Alternatively, a similar subpattern may be formed into each patterned ring but at different angular positions around the cylindrical sleeve. Alternatively, the subpattern 300 may be periodically similar in shape and position across the patterned rings 114 or 114′ assembled onto the patterned roller 100A and 100B.

The one or more patterned rings 114 or 114′ may each be uniquely numbered to identify positions on the cylindrical sleeve 120 or 120′ with respect to each other and any spacer rings. Similarly, the zero or more spacer rings 214 or 214′ may each be uniquely numbered to identify their position on the cylindrical sleeve 120 or 120′ with respect to each other and the patterned rings 114 or 114′.

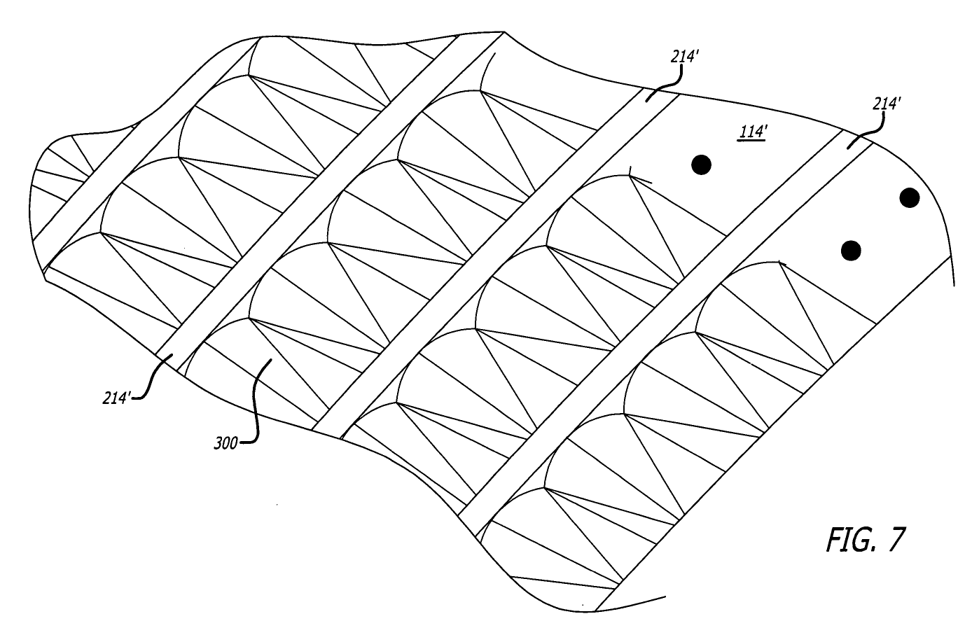

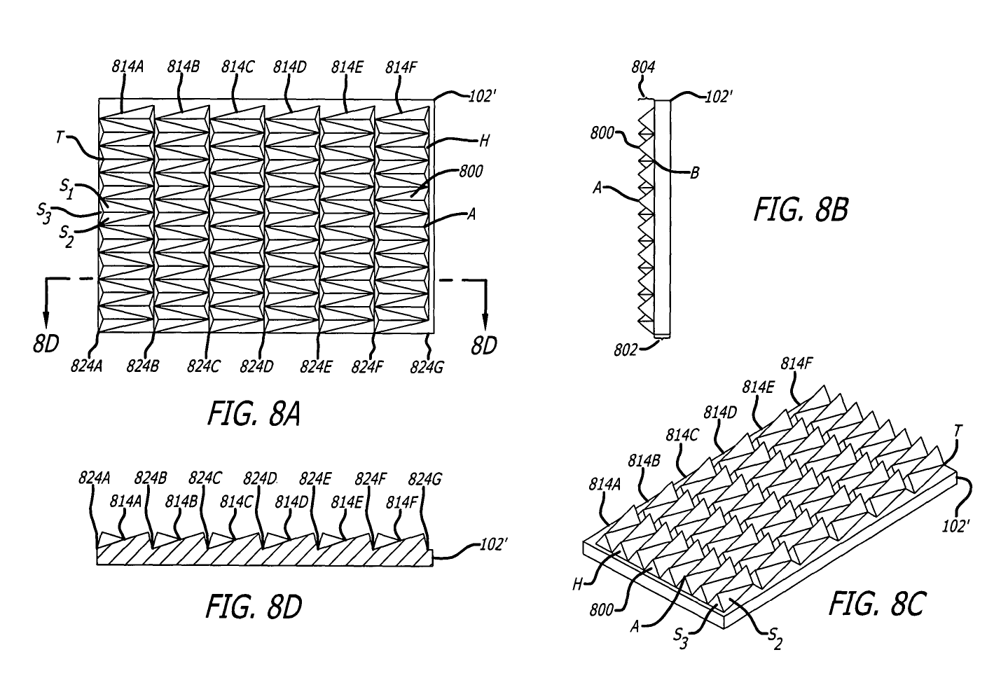

Referring now to FIGS. 8A-8D, views of a portion of the reflective film 102 is illustrated as a reflective film 102′. FIG. 8A illustrates a top view of a reflective film 102′. FIG. 8B illustrates a side view of the reflective film 102′. FIG. 8C illustrates a perspective view of the reflective film 102′. FIG. 8D illustrates a cross section of the reflective film 102′. Because either embodiment of the patterned roller 100A and 100B can form a pattern in the film, the patterned roller will generally be referred to as patterned roller 100.

As previously discussed, as the film 102 is pushed or pulled from between the patterned roller 100 and the roller 104, an overall pattern is formed in a surface of the reflective film 102. The pattern formed in the reflective film 102 by the patterned roller 100 is not a molding process.

The reflective film 102′ includes a plurality of full corner cubes 800. The reflective film 102′ includes a body region 802 and a microstructure region 804. The plurality of corner cubes 800 are formed in the microstructure region 804 of the reflective film 102′. The body region 802 of the reflective film 102′ supports the microstructure region 804.

In an embodiment of the pattern of the patterned roller 100, the plurality of full corner cubes 800 are arranged into columns 814A-814F. Each column 814A-814F is separated by respective lines, slots or grooves 824A-824G.

Each corner cube 800 has a base edge (B), a tail (T), a head (H), a vertex or apex (A), and three surfaces (S1, S2, and S3) at which light may be reflected. The apex, where the three surfaces (S1, S2, and S3) join together at a corner, is nearer the head of each corner cube 800. The tail of each corner cube 800 is opposite the head. The base edge of each corner cube 800 may be level with a base surface of the reflective film. Along a column, the base edge of one corner cube 800 may join the base edge of the next corner cube. Each corner cube resembles a tetrahedron. That is, each corner cube resembles a triangular pyramid having three triangular sides and a triangular base. The triangular pyramid shape may or may not be symmetrical. That is three triangular sides may have non-equal sides to form an asymmetrical triangular pyramid or a non-regular tetrahedron.

Within each column, each corner cube 800 reverses orientation from the next down the respective column. Each corner cube 800 along a row, (i.e., across columns), has its orientation aligned with the next. For example, in one row the corner cubes 800 are aligned with the tail on the left side and the head on the right side of the reflective film. In the next row adjacent thereto, the corner cubes 800 are aligned with the head on the left side and the tail on the right side of the reflective film 102.

The reflective film 102′ illustrated in FIGS. 8A-8D may only be a portion of an entire sheet or roll of reflective film. For the portion illustrated in FIGS. 8A-8D, the reflective film 102′ may be formed by six patterned shims 114 or 114′ and seven spacer shims 214 or 214′ of the patterned roller 100. Each column 814A-814F of corner cubes formed in the reflective film is formed by the respective patterned shim 114 or 114′. Each of the grooves 824A-824G between columns 814A-814F in the reflective film 102′ is formed by the respective spacer shims 214 or 214′.

In one embodiment, the corner cubes formed into the surface of the reflective film 102 are male corner cubes. In another embodiment the corner cubes formed in the surface may be female corner cubes. In either case, the overall pattern rolled into the reflective film 102 may be a seamless continuous pattern.

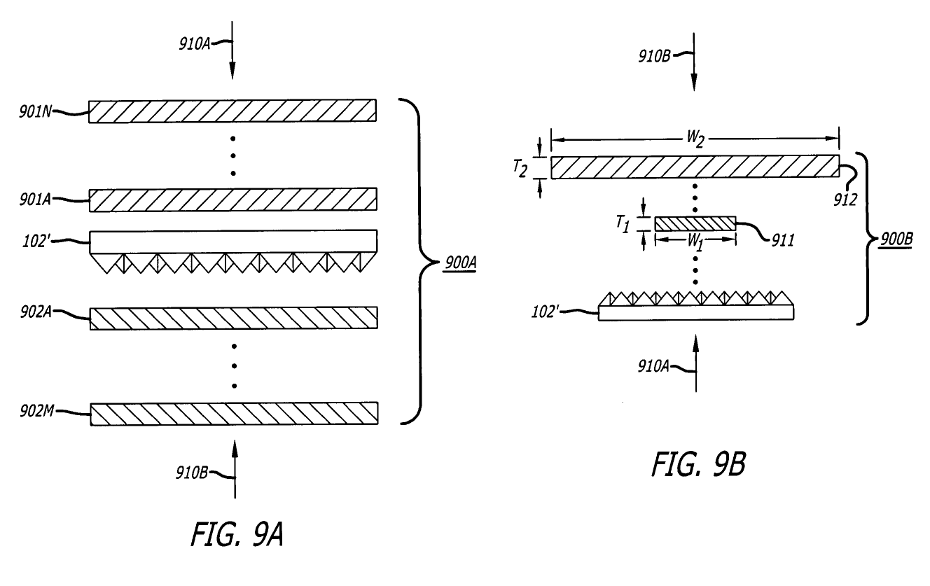

Referring now to FIGS. 9A-9B, the reflective film 102 or 102′ may be laminated with other layers of materials depending upon the desired application to form a reflective laminate sheeting. The optical microstructures cut or imprinted into the surface of the reflective film 102 or 102′, such as full corner cubes, may be formed therein to reflect light which is incident from a front side of the optical microstructures or from a back side of the optical microstructures.

In FIG. 9A, light rays 910A are coupled into the back side of the optical microstructures and light rays 910B are coupled into the front side of the optical microstructures in the reflective layer 102′ of the reflective laminate sheeting 900A.

In FIG. 9B, light rays 910A are coupled into the back side of the optical microstructures and light rays 910B are coupled into the front side of the optical microstructures in the reflective layer 102′ of the reflective laminated sheeting 900B.

FIG. 9A further illustrates that one or more layers of other materials may be laminated on either or both top and bottom of the reflective layer 102′. The one or more layers 901A-901N may be laminated together with the reflective layer 102′ on a first surface. The one or more layers 902A-902N may be laminated together with the reflective layer 102′ on a second surface opposite the first surface.

FIG. 9B further illustrates the one or more layers of other materials, which may be laminated together with the reflective layer 102′, may have various widths and various thicknesses. For example, layer 911 has a width W1 and a thickness T1. Layer 912 has a width W2 and a thickness T2 each differing respectively from the width W1 and the thickness T1 of layer 911, for example. The lengths of the layers may also vary along the laminated film. Furthermore, the widths, thicknesses, and lengths of the other material layers need not be uniform across the reflective layer 102′.

The differing widths and lengths may be used to alter the reflectivity efficiency to display lettering, for example, or alter the color or frequency of the reflected light back towards a source, for example. The differing thicknesses may similarly be used to alter the reflectivity efficiency or may be related to the amount of material needed to provide a desired effect. The type of material used to form the reflective sheet 102 may alter the reflectivity efficiency of the reflective laminate. The type of the other materials, their index of refraction, and position with respect to the optical microstructures, may also alter the reflectivity efficiency of any reflective laminate. Furthermore, the reflectivity efficiency can be maximized for some frequencies or colors of light and minimized for other frequencies or colors of light by appropriate selection of the other layers of material, their thicknesses, and dimensions. Some of the other material layers may be transparent or opaque to certain desired wavelengths or frequencies of light and not others.

The reflective sheet layer 102 may be a polymer or plastic layer such as a thermoplastic or other material layer having optical properties that can be cut or patterned by the patterned roller 100. In one embodiment the layer 102 is a transparent semicrystalline polymer.

Examples of the types of other material layers that may be laminated together with the reflective layer 102 are a reflective film coating, color pigments, ink, phosphor, silica, polarizer, sealant, protective coating, binder, substrate, adhesive, and removable release sheet layer. The adhesive layer may be a pressure sensitive adhesive, a heat activated adhesive, or a radiation activated adhesive. The removable release sheet layer may be used to protect the adhesive layer until the reflective laminate is ready to be coupled to a surface.

The silica (silicon-di-oxide) may be used to fill into voids formed by the optical microstructures into an even level surface. One form of silica that may be used is mica.

The protective coating layer may be provided to resist abrasion and stains such as may be experienced by tires running over a pavement marker. The protective coating layer may also provide soil and dew repellency to maintain the original reflectivity efficiency of the laminate after exposure to moisture and dirt or grime.

A substrate may be provided to fix the reflexive laminate to a surface by mechanical means, such as by sewing into a garment or shoe. The binder layer or adhesive layer may be provided to affix the reflective laminate to a surface.

A reflective film, such as a metal foil formed of a thin layer of aluminum, brass, copper, gold, nickel, platinum, silver, or titanium may also be used to reflect light and/or provide a difference in index of refraction. The reflective film may be laminated or alternately sprayed onto the reflective layer 102. Other materials that may be used to form a reflective film layer such as titania, zirconia, cobalt/iron mixture, zirconia-di-oxide, zinc oxide, white lead, antimony oxide, zinc sulfide, alumina and magnesia.

The other layers may also be multiple alternating layers of two polymers each with a thickness less than one hundred nanometers, selected to have a mismatch in refractive indices to cause constructive interference of light.

The layers may be laminated together by pressure and heating in the extrusion process. Alternatively and/or conjunctively, the layers may be laminated together by pressure and the use of a thin layer of glue, binder, or epoxy selectively used between the layers to hold multiple layers together.

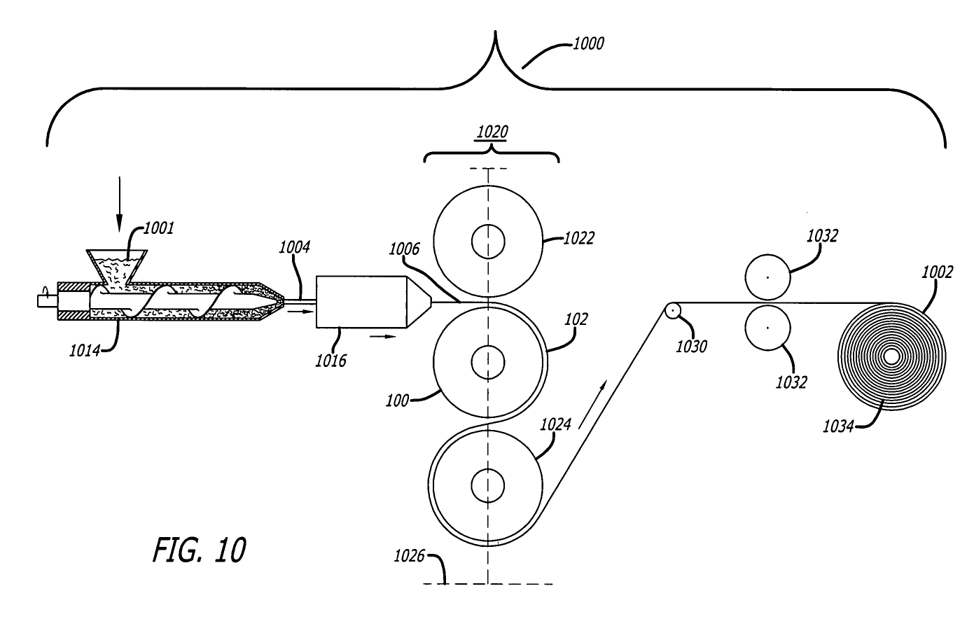

Referring now to FIG. 10, an exemplary schematic of a processing line, production line, or manufacturing system 1000 is illustrated. In one embodiment, the manufacturing system 1000 is a coextrusion system to extrude a reflective film. The flow of materials in the exemplary manufacturing system 1000 proceeds from left to right across the page. The manufacturing system 1000 receives as in an input a plurality of pellets, beads, pulverized, chunks, or other forms of raw materials 1001 in order to form a roll of reflective film 1002 as its output.

The exemplary manufacturing system 1000 includes an extruder 1014, an extrusion die 1016, a patterned roller stack 1020, an idler roller (“idler”) 1030, a pair of nip rollers 1032, and a wind-up roller 1034. The exemplary manufacturing system 1000 may further include a feeder, a blender, a screen pack filter, a gear pump, a feed block, a thickness gauge, a slitter, and a dancer in various positions of the manufacturing system. Additionally, the exemplary manufacturing system 1000 may have one or more flows of molten or liquefied material that can be combined by a feedblock for multiple layers of the reflective film. Alternatively, a laminating machine may be used to laminate multiple layers of materials together including a reflective film layer 102. In another case, a vacuum former may be used to apply additional material layers to the reflective film layer 102.

The patterned roller stack 1020 includes a first roller 1022, the patterned roller 100, and a second roller 1024. The patterned roller 100 is driven by a motor to pull the extruded film into the patterned roller stack 1020 for patterning. A first surface of the extruded film makes intimate contact with the patterned roller 100 so that the cylindrical pattern of the roller 100 may be imprinted or cut into the first surface. The first roller 1022 at the top of the stack presses against a second surface of the extruded film to squeeze the film between the patterned roller 100 and the first roller 1022. The first roller 1022 can also partially cool the extruded film. Thus, the first roller 1022 may also be referred to as a top chill roller. The second roller 1024 at the bottom of the stack may be driven by a motor to pull the reflective film out through the patterned roller stack 1020. The second roller 1024 can also cool the extruded reflective film into a solid state. Thus, the second roller 1024 may also be referred to as a bottom chill roller. The patterned roller stack 1022 may further include a chassis, stand, or frame 1026 to which the first roller 1022, the patterned roller 100, and the second roller 1024 may be rotatably coupled. The frame 1026 supports the positions of the rollers therein and may move one or more rollers together in order to squeeze and apply pressure to the extruded film.

To begin manufacturing of the extruded reflective film, raw materials 1001 of appropriate proportions are coupled into the extruder 1014. The extruder 1014 heats up the raw material from a solid state into a liquefied or molten state, mixes the raw materials together, and pushes the molten raw materials out as liquefied or molten raw materials 1004.

It is desirable to modify the cross section of the liquefied raw materials 1004 into a cross section of a layer or a sheet of material. The liquefied raw materials 1004 are coupled into the extrusion die 1016. The extrusion die 1016 converts a first cross section of the liquefied raw materials into a thin wide cross section of a sheet, film or layer of extruded film 1006. The extruded film 1006 has a pair of side edges and a top surface and a bottom surface. The side edges of the extruded film 1006 are relatively thin and the top and bottom surface of the extruded film 1006 are relatively wide.

The flattened sheet, film, or layer of extruded film 1006 is coupled into the patterned roller stack 1020 between the first roller 1022 and the patterned roller 100.

As discussed previously, the patterned roller 100 includes the cylindrical pattern 400 formed by the one or more patterned rings 114 or 114′ and/or the zero or more spacers 214 or 214′. The continuous cylindrical pattern 400 of the patterned roller 100 is imprinted, pressed or cut into a surface of the sheet of extruded film 1006 to form a microstructure therein as the film 102. In one embodiment, the microstructures in the film are full corner cubes and the film 102 is an extruded reflective film or layer. The continuous cylindrical pattern 400 of the patterned roller 100 forms the continuous pattern 800 in the surface of the reflective layer 102.

The reflective layer 102 wraps around a portion of the second roller 1024 of the patterned roller stack 1026 to re-orient the film 102. The second roller 1024 further provide a means for added cooling of the sheet of material into a solid state from a soft state. The sheet of material output from the patterned roller stack 1020 is then coupled towards the wind-up roller 1034.

The film 102 wraps over the idle roller 1030 to alter the angle over which the film flows in the manufacturing system. The film 102 is pulled over the idle roller 1030 by the pair of nip rollers 1032. Each of the nip rollers 1032 are rollers driven by a motor. The film 102 is squeezed between the pair of nip rollers 1032 and flows through towards the wind-up roller 1034.

The wind-up roller 1034 receives the sheet of the film 102 and winds it up into a roll 1002. In the case that the film 102 is extruded reflective film, the roll 1002 is a reflective film roll of extruded reflective sheeting or film. The wind up roller 1034 is driven in order to tightly wind the extruded film into a spiral roll. The wind up roller 1034 may include a spool having edges to maintain alignment of the film 102 as its wound up into the spiral roll.

In summary, the manufacturing system 1000 includes an extrusion or liquefaction process, a flattening process, a patterning process, and a wind-up process. The extrusion or liquefaction process is performed by the extruder 1014. The flattening process is performed by the extrusion die 1016. The patterning process is performed by the patterned roller stack 1020. The wind-up process is performed by the nip rollers 1032 and the wind-up roller 1034.

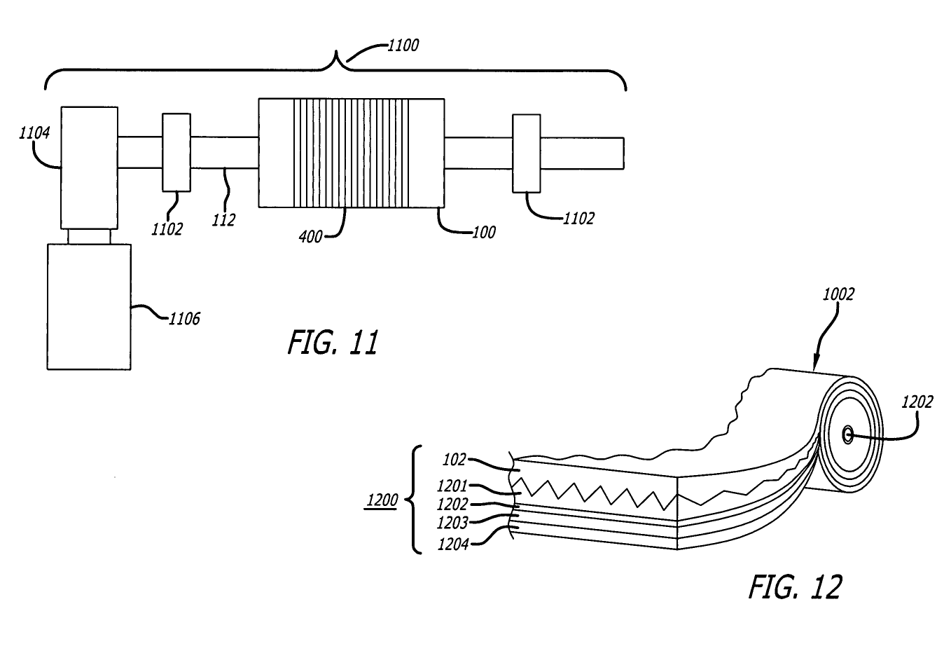

Referring now to FIG. 11, an exemplary patterned roll assembly 1100 is illustrated. The patterned roll assembly 1100 includes the patterned roller 100, a pair of bearings 1102, a gear box 1104, and an AC motor 1106 coupled together as illustrated in FIG. 11. The pair of bearings 1102 provide support points to the patterned roller 100 coupled to the axle or journal 112 on the inside. The outside of the pair of bearings 1102 may couple to the frame of the patterned roller stack 1020 in order to support the patterned roll assembly 1100 therein. The pair of bearings 1102 allow the patterned roller 100 to rotate within the patterned roller stack. Each of the pair of bearings 1102 may be a roller bearing.

The motor 1106 includes a rotating shaft to drive the gear box 1104. The gear box 1104 includes gears to ratio the rotations of the rotating shaft to rotations of the patterned roller. In one embodiment, the ratio of the gearbox reduces the number of rotations of the motor that are transferred to the patterned roller. In another embodiment, the ratio of the gearbox 1104 increases the number of rotations of the motor that are transferred to the patterned roller 100. In yet another embodiment, the ratio of the gearbox 1104 is one and the same number of rotations of the motor 1106 are transferred to the patterned roller 100. The ratio of the gearbox 1104 may be selective similar to a transmission to vary the rotational speed of the patterned roller 100.

Referring now to FIG. 12, a roll 1002 including the reflective sheeting 120 is illustrated. As previously discussed other layers of materials may be laminated around the reflective sheeting 102 to form a reflective laminate 1200. The reflective laminate includes the reflective sheeting 102 and one or more other layers of other materials, such as layers 1201-1204 for example. As previously discussed and illustrated in FIGS. 9A-9B, the one or more layers of other materials may be sized differently and located on either side of the reflective sheeting.

Thus, the roll 1002 may be a roll of reflective sheeting 102 alone, without other layers. Alternatively the roll 1002 may be a roll of a reflective laminate 1200 including other layers laminated together with the reflective sheeting 102. The roll 1002 may further include a center cylinder core 1210 upon which the reflective sheeting 102 or reflective laminate 1200 may be spiral wound. The center cylinder core 1210 may be a spool including edges to align the reflective sheeting 102 or reflective laminate 1200 as its wound around by the wide up roller.

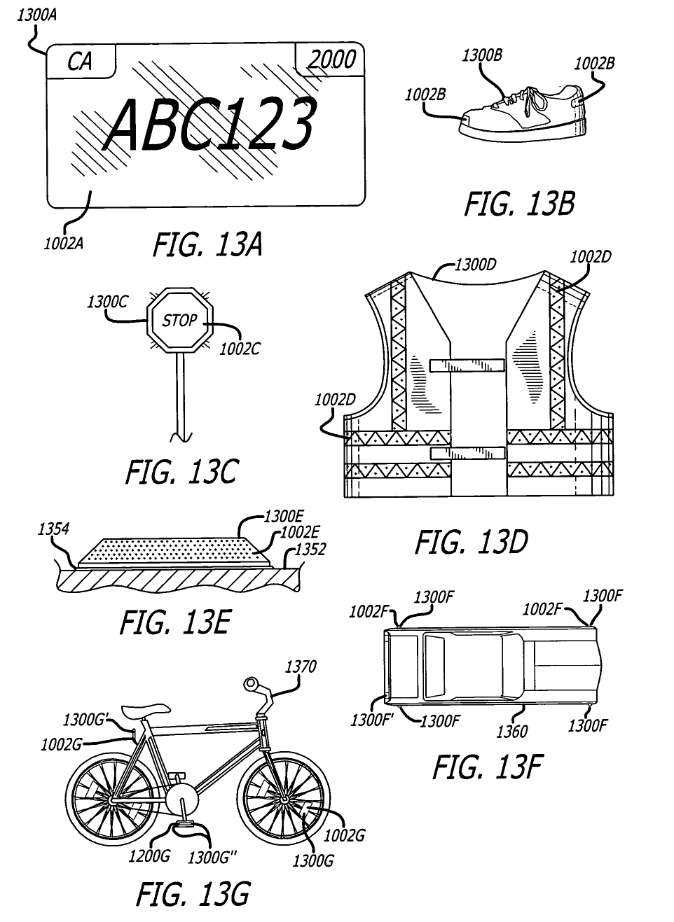

Referring now to FIGS. 13A-13G, exemplary applications of the reflective film 102 are illustrated. The reflective film 102 can be used in a broad range of reflector applications including but not limited to reflective signage, pavement markers, sportswear, and safety clothing. Reflectors and reflective film can be incorporated into articles of manufacture in a number of ways. The reflector can be formed as a part of the article, such as in a spoke reflector for a bicycle or a tail reflector for a vehicle. Alternatively, the reflector can be formed into a sheet or a strip of material layers and then applied or coupled to the article. Reflective tape can be applied to clothing, for example. Reflective sheeting or film may be applied to highway signage or markers. The reflective film 102 or reflective laminate may be spooled or wound off of the roll 1002 and applied to the article during manufacturing.

In FIG. 13A, the reflective film 1002A representing a portion of the roll 1002 is embodied in a license plate 1300A. The letters and numbers may be formed by including one or more different colored ink layers to a reflective laminate 1200.

In FIG. 13B, the reflective film 1002B representing a portion of the roll 1002 is embodied in a shoe 1300B. The reflective film 1002B may include a substrate to be sewn to the shoe 1300B and/or an adhesive to be glued thereto.

In FIG. 13C, the reflective film 1002C representing a portion of the roll 1002 is embodied in a highway sign 1300C, such a stop sign.

In FIG. 13D, the reflective film 1002D representing a portion of the roll 1002 is embodied in an article of clothing 1300D, such as a vest.

In FIG. 13E, the reflective film 1002E representing a portion of the roll 1002 is embodied in a pavement marker 1300E. The pavement marker 1300E is affixed to pavement 1352 by an adhesive 1354 as illustrated in FIG. 13E.

In FIG. 13F, the reflective film 1002F representing a portion of the roll 1002 is embodied in reflectors 1300F and 1300F′ of an automobile 1360. Reflectors 1300F are side markers or side reflectors of the automobile 1360. The reflectors 1300F′ are rear reflectors or front reflectors of the automobile 1360.

In FIG. 13G, the reflective film 1002G representing a portion of the roll 1002 is embodied in reflectors 1300G and 1300G′ and 1300G″ of a bicycle 1370. The reflectors 1300G are spoke or wheel reflectors. The reflectors 1300G′ are front or rear bicycle reflectors. Reflector 1300G″ are pedal reflectors.

Because the patterned roller acts as a printing or cutting roller and not a mold, there is little to no curing time needed for the optical reflective sheeting—providing a high speed method of forming extruded reflective sheeting. The patterned roller allows a continuous sheet of full corner cubes to be formed into a surface of a sheet of optical material. By using the patterned roller, the pattern over the continuous sheet is seamless. The patterned roller is adaptable. That is, the pattern formed by the patterned roller can be altered by changing the patterned rings and the spacer rings with another configuration of patterned rings and spacer rings.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art after reading the disclosure. For example, the patterned roller is described herein as being used to manufacture an extruded reflective film. However, the patterned roller may also be used to form other types of structures or microstructures in the surface of a film or sheet of material. Rather than limiting the invention to the specific constructions and arrangements shown and described herein, the invention should be construed according to the following claims.

1. A patterned roller for a manufacturing process, the patterned roller comprising:
an axle;
a cylindrical sleeve around the axle, the cylindrical sleeve coaxial with the axle;
one or more patterned rings slidingly engaged with the cylindrical sleeve and perpendicular thereto, each of the one or more patterned rings having a subpattern of a pattern of the roller in an outer edge, each of the one or more patterned rings having an inner edge shaped to slidingly engage the cylindrical sleeve, the one or more patterned rings coaxial with the axle;
a first end flange and a second end flange sandwiching the cylindrical sleeve and the one or more patterned rings, the first end flange and the second end flange coupled perpendicular and coaxial to the axle; and
one or more fasteners coupled between the first end flange and the second end flange, the one or more fasteners to hold the first end flange and the second end flange together sandwiching the cylindrical sleeve and the one or more patterned rings.

2. The patterned roller of claim 1, wherein
the one or more patterned rings, each having the subpattern, form the pattern of the roller for rolling onto a surface of a sheet of material.

3. The patterned roller of claim 1, wherein
the one or more fasteners are one or more pairs of nuts and bolts coupled together.

4. The patterned roller of claim 1, further comprising:
one or more spacer rings slidingly engaged with the cylindrical sleeve and perpendicular thereto, each of the one or more spacer rings having an edge pattern of the pattern of the roller in an outer edge, each of the one or more spacer rings having an inner edge shaped to slidingly engage the cylindrical sleeve, the one or more spacer rings coaxial with the axle.

5. The patterned roller of claim 4, wherein
the one or more patterned rings, each having the subpattern, and the one or more spacer rings form the pattern of the roller for rolling onto a surface of a sheet of material.

6. The patterned roller of claim 4, wherein
a pair of the one or more spacer rings sandwiches a patterned ring of the one or more patterned rings.

7. The patterned roller of claim 1, further comprising:
one or more rods parallel with the axle coupled between the first and second flanges, the one or more rods slidingly engaged with the one or more patterned rings and perpendicular thereto; and wherein
each of the one or more patterned rings having an opening to slidingly engage the one or more rods and hold a fixed rotational position around the axle.

8. The patterned roller of claim 1, wherein
the cylindrical sleeve includes a guide slot parallel with the axle; and
each of the one or more patterned rings includes a guide tab in an inner edge to slidingly engage the guide slot and hold a fixed rotational position around the axle.

9. The patterned roller of claim 1, further comprising:
a motor to drive the roller;
first and second bearings to support the roller, the first bearing located near a first end and the second bearing located near a second end of the axle; and
a gear box coupled between the motor and the first end of the axle, the gear box having gearing to proportionally rotate the roller in response to rotations of a shaft of the motor.

10. A roller stack for forming a pattern in a surface of a film, the roller stack comprising:
a first roller; and
a second roller, the second roller having a cylindrical pattern to roll over the surface of the film and form the pattern therein, the second roller including,
a rotatable shaft, and
one or more rings coupled in parallel together to the shaft, an outer edge of each of the one or more rings having a respective subpattern aligned together to form the cylindrical pattern; and
the film between the first roller and the second roller, the second roller to press against the surface of the film to form the pattern therein.

11. The roller stack of claim 10, further comprising:
a third roller to cool the film.

12. The roller stack of claim 10, further comprising:
a motor coupled to drive the rotatable shaft of the second roller,
first and second bearings to support the second roller, the first bearing located near a first end and the second bearing located near a second end of the rotatable shaft; and
a gear box coupled between the motor and the rotatable shaft, the gear box having gearing to proportionally rotate the second roller in response to rotations of the motor.

13. The roller stack of claim 12, further comprising:
a third roller to cool the film.

14. The roller stack of claim 13, further comprising:
a frame to rotatably support the first roller, the second roller and the third roller in parallel together.

15. A manufacturing system for the manufacture of an extruded film, the manufacturing system comprising:
an extruder to receive solid raw materials, the extruder further to heat and extrude liquefied raw materials; and
an extrusion die to receive the liquefied raw materials, the extrusion die further to flatten the liquefied raw materials into a thin wide sheet of semi-sold raw materials; and
a roller stack to receive the thin wide sheet of semi-solid raw materials, the roller stack including,
a first roller and a second roller oriented to receive the thin wide sheet of semi-solid raw materials between them, the second roller further having a cylindrical pattern, formed out of one or more rings, to roll over a surface of the thin wide sheet of the semi-solid raw materials and form a pattern therein, the roller stack to output a thin wide sheet of solid raw materials having the pattern;
a pair of nip rollers to pull on the thin wide sheet of solid raw materials to convey the thin wide sheet of solid raw materials; and
a windup roller to receive the thin wide sheet of solid raw materials and roll it up into a roll of sheeting.

16. The manufacturing system of claim 15, wherein
the first roller to further cool the thin wide sheet of semi-solid raw materials.

17. The manufacturing system of claim 15, wherein
the roller stack further includes
a third roller to cool the thin wide sheet of semi-solid raw materials into the thin wide sheet of solid raw materials.

18. The manufacturing system of claim 15, wherein
the second roller presses against the surface of the thin wide sheet of semi-solid raw materials to form the pattern therein.

19. The manufacturing system of claim 15, wherein
the second roller further has
a rotatable shaft,
a motor coupled to one end of the rotatable shaft to drive the rotatable shaft, and
one or more rings coupled in parallel together to the shaft, in an outer edge each of the one or more rings having a respective subpattern aligned together to form the cylindrical pattern of the second roller.

20. A method of manufacturing a patterned film, the method comprising:
providing raw materials into a liquefied form;
shaping the liquefied form of raw materials into a thin sheet;
rolling a patterned roller over a surface of the thin sheet, the patterned roller including one or more rings each having a respective subpattern of a cylindrical pattern of the patterned roller; and
winding the thin sheet into a roll.

21. The method of claim 20, further comprising:
cooling the thin sheet using a first chill roller and a second chill roller.

22. The method of claim 20, wherein,
a wind-up roller for the winding of the thin sheet into the roll.

23. The method of claim 20, wherein,
an extruder die for the shaping of the liquefied form of the raw materials into the thin sheet.

24. The method of claim 20, wherein,
an extruder for the providing of the raw materials into the liquefied form.

25. The method of claim 20, wherein,
prior to the winding of the thin sheet, the method further comprises
pulling the thin sheet.

26. The method of claim 25, wherein,
a nip roller pair for the pulling of the thin sheet.

27. The method of claim 25, wherein,
prior to the pulling of the thin sheet, the method further comprises
redirecting the thin sheet.

28. The method of claim 27, wherein,
an idler roller for the redirecting of the thin sheet.

29. A roll of extruded film formed by the method of
extruding raw materials into a liquefied form;
shaping the liquefied form of raw materials into a thin sheet;
rolling a patterned roller over a surface of the thin sheet, the patterned roller including one or more rings each having a respective subpattern of a cylindrical pattern of the patterned roller;
cooling the thin sheet; and
winding the thin sheet into a roll.

30. A method of manufacturing a reflective film, the method comprising:
coupling a film into a roller stack;
rolling and pressing a corner cube pattern of a patterned roller into a surface of the film to form the reflective film, the corner cube pattern formed of subpatterns of one or more patterned rings; and
cooling the reflective film into a solid state.

31. The method of claim 30, wherein,
a chill roller for cooling the reflective film into the solid state.

32. The method of claim 30, further comprising:
pulling the film into the roller stack.

33. The method of claim 32, wherein,
the patterned roller is driven to pull the film into the roller stack.

34. The method of claim 30, wherein,
a first chill roller and the patterned roller for rolling and pressing the corner cube pattern of the patterned roller into the surface of the film to form the reflective film.

35. The method of claim 34, wherein,
a second chill roller for cooling the reflective film into the solid state.

36. The method of claim 35, wherein,
the roller stack includes the patterned roller, the first chill roller, and the second chill roller.

37. The method of claim 30, further comprising:
pulling the reflective film out of the roller stack.

38. The method of claim 37, wherein,
the second chill roller is driven to pull the reflective film out through the roller stack.

39. A reflective film formed by the method of
coupling a film into a roller stack;
rolling and pressing a corner cube pattern of a patterned roller into a surface of the film to form the reflective film, the corner cube pattern formed of subpatterns of one or more patterned rings; and
cooling the reflective film into a solid state.

40. A roll of reflective laminate sheeting including a layer of reflective film formed by the method of
coupling a film into a roller stack;
rolling and pressing a corner cube pattern of a patterned roller into a surface of the film to form the reflective film, the corner cube pattern formed of subpatterns of one or more patterned rings; and
cooling the reflective film into a solid state.

41. An article of manufacture including a portion of a reflective film formed by the method
coupling a film into a roller stack;
rolling and pressing a corner cube pattern of a patterned roller into a surface of the film to form the reflective film, the corner cube pattern formed of subpatterns of one or more patterned rings; and
winding the reflective film into a roll.

42. The article of manufacture of claim 41, wherein
the article of manufacture is one or more of
a license plate, a shoe, a highway sign, an article of clothing, a pavement marker, an automobile reflector, and a bicycle reflector.

43. A roll of film comprising:
an optical film rolled up into a roll, the optical film including a first side having
a plurality of columns of full corner cubes,
each adjacent column of full corner cubes having a pattern of full corner cubes offset from the next, and
a groove between each of the plurality of columns of full corner cubes.

44. The roll of film of claim 43, wherein
the optical film further includes a second side having
an adhesive to adhere the optical film to a surface.

45. The roll of film of claim 44, wherein
the second side of optical film further has
a release layer to protect the adhesive.

46. The roll of film of claim 43, wherein
the full corner cubes in the first side reflect incident light, and
the optical film further includes a second side having
a reflective layer to further reflect the incident light.

47. The roll of film of claim 43, wherein
the full corner cubes in the first side reflect incident light, and
the first side of the optical film further has
a reflective layer to further reflect the incident light.

48. The roll of film of claim 47, wherein
the first side of the optical film further has
an adhesive to adhere the optical film to a surface.

49. The roll of film of claim 43, wherein
the plurality of columns of full corner cubes is a seamless plurality of columns of full corner cubes.

50. A reflective film comprising:
an optical material formed into a body region and an optical region, the body region to support the optical region; and
the optical region having N columns of corner cubes without seams, the optical region formed by
rolling a patterned roller over a surface of a film, the patterned roller including N patterned rings.

51. The reflective film of claim 50, wherein
the optical region further has M grooves interspersed between the N columns of corner cubes, and
the optical region being further formed by the patterned roller further including M spacer rings.

52. The reflective film of claim 50, wherein
the optical material is a thermoplastic.

53. A reflector to reflect an incident light source of an incident angle back at a reflective angle, the reflector including:
a laminate having a reflective layer, the reflective layer including a surface comprised of
N columns of full corner cubes without seams, each of the full corner cubes being shaped as a triangular pyramid, and
M grooves, each groove separating a pair of columns of full corner cubes without seams.

54. The reflector of claim 53, wherein
each full corner cube includes a base, a head, a tail, and three reflective surfaces joined at an apex.

55. The reflector of claim 53, wherein
each full corner cube is a male corner cube.

56. The reflector of claim 53, wherein
the full corner cubes are aligned in rows.

57. The reflector of claim 56, wherein
the full corner cubes in even columns are aligned in rows from head to tail and the full corner cubes in odd columns are aligned in rows from tail to head.

58. The reflector of claim 53, wherein
the laminate further includes an adhesive layer to couple the reflective film to a surface.

59. The reflector of claim 53, wherein
the N columns of full corner cubes without seams and the M grooves are formed by
rolling a patterned roller over a surface of a film, the patterned roller including N patterned rings and M spacer rings.

60. The reflector of claim 53, wherein
the reflector is one or more of a license plate, a shoe, a highway sign, an article of clothing, a pavement marker, an automobile reflector, and a bicycle reflector.

61. The reflector of claim 53, wherein
each of the full corner cubes is shaped as an asymmetrictriangular pyramid.

62. The reflector of claim 53, wherein
each of the full corner cubes is shaped as a symmetrictriangular pyramid.
